(19) United States
(12) Patent Application Publication
(10) Pub. No.: US 2025/0065844 A1
(43) Pub. Date: Feb. 27, 2025

(54) USER AUTHENTICATION FOR VEHICLE ACCESS AND IN-CABIN EXPERIENCE USING INFRARED IMAGING

(71) Applicant: NVIDIA Corporation, Santa Clara, CA (US)

(72) Inventors: Rajath SHETTY, Sunnyvale, CA (US); Braeden Chance Syrnyk, Santa Clara, CA (US); Ratin Kumar, Cupertino, CA (US)

(21) Appl. No.: 18/453,963

(22) Filed: Aug. 22, 2023

(51) Int. Cl. B60R 25/25; B60R 25/01; B60R 25/30; G06V 10/26; G06V 20/59; G06V 40/12; G06V 40/13; G06V 40/14; H04N 23/23

(52) U.S. Cl. CPC B60R 25/25; B60R 25/01; B60R 25/305; G06V 10/26; G06V 20/59; G06V 40/1318; G06V 40/1365; G06V 40/14; H04N 23/23

(57) ABSTRACT

In various examples, infrared image data may be used to detect a subcutaneous characteristic(s) (e.g., a palm vein topology) of a person (e.g., a person requesting entry to a vehicle, a vehicle occupant) and authenticate the user based on the detected subcutaneous characteristic(s). For example, infrared image data representing one or more acquired subcutaneous characteristics (e.g., a topology of veins and/or other blood vessels in a region of the authenticating user's palm, hand, neck, forearm, face, fingertip, eye, etc.) may be generated. Hand and/or palm detection may be applied to detect a region depicting the user's hand or palm, and that region (or some subset thereof) may be segmented to generate a representation of an acquired vein topology. The acquired vein topology may be compared with one or more reference vein topologies stored in a database to determine whether the acquired vein topology matches one of the reference vein topologies.

### BACKGROUND

Vehicle designs typically rely on some type of authentication to ensure that only authorized users gain access to a vehicle. Traditional physical keys are one of the most straightforward authentication methods. The vehicle's owner or authorized operator uses a unique key that fits into the vehicle's lock to gain access. Remote keyless entry systems (e.g., key fobs or smart keys) can grant vehicle access by emitting a radio frequency signal that communicates with electronics in the vehicle to unlock the doors when the user is in close proximity to the vehicle. Some keyless entry and start (e.g., push-to-start) systems use proximity sensors to detect the presence of an authorized key fob and unlock the doors when the user presses a button on the door handle while the key fob is near the vehicle. Push-to-start systems detect when an authorized key fob is inside the vehicle and start the engine when the user presses a start button while the key fob is inside the vehicle. Some modern vehicles are equipped with biometric authentication systems such as fingerprint scanners or facial recognition systems. These systems may identify an authorized user based on their unique fingerprint or detected facial features, and may grant access to the vehicle accordingly.

One of the primary drawbacks with existing biometric authentication systems stems from their reliance on prominent physical traits for user authentication. For example, conventional facial recognition systems in existing vehicles can be spoofed by positioning a picture or three-dimensional (3D) cutout of the vehicle's owner in front of the system's camera to trick the system into falsely authenticating an intruder as the owner. In another example, conventional facial recognition systems can experience reduced accuracy and failures in situations where a salient physical attribute is occluded (e.g., when the user is wearing a mask or other facial covering). Accordingly, existing biometric authentication techniques are prone to hacking and error, potentially risking vehicle and/or passenger safety. As such, there is a need for improved biometric authentication techniques that can reduce the risk of unauthorized entry and/or improve convenience in accessing and operating a vehicle.

### SUMMARY

Embodiments of the present disclosure relate to personal (e.g., subcutaneous) authentication for vehicle access and in-cabin experience. Systems and methods are disclosed that use infrared image data to detect one or more subcutaneous characteristics (e.g., a representation of a vein topology, such as palm vein map) of a person (e.g., a person requesting entry to a vehicle, a vehicle occupant), and authenticate the person based on the detected subcutaneous characteristic(s).

In contrast to conventional systems, such as those described above, an infrared camera may use a near-infrared light source (e.g., with a wavelength of 850 nanometers, 940 nanometers, etc.) to generate infrared image data representing one or more acquired subcutaneous characteristics (e.g., a topology of veins and/or other blood vessels in a region of the authenticating user's palm, hand, neck, forearm, face, fingertip, eye, etc.). As such, the infrared image data may be segmented to generate a representation of the one or more acquired subcutaneous characteristics (e.g., a binary map representing segmented veins), and the acquired subcutaneous characteristic(s) may be matched to a corresponding reference subcutaneous characteristic(s) saved in a database to authenticate the user.

In an example embodiment involving access to an interior space (e.g., a vehicle cabin), an image acquisition loop may be initiated upon detecting a request to unlock door(s) (e.g., via a key fob or smart key, via the push of a button such as one on a door handle), upon detecting the presence of an authorized key fob or smart key via a proximity sensor, and/or otherwise. Taking palm vein authentication as an example, the authenticating user may position their hand in front of an infrared camera positioned and/or oriented to view the exterior of the vehicle, and the infrared camera may be used to generate an infrared image of the user's hand. Hand and/or palm detection may be applied to the infrared image to detect a region depicting the user's hand or palm, and that region (or some subset thereof) may be segmented to generate a representation of an acquired vein topology.

In an example embodiment involving authentication of an occupant of an interior space, an image acquisition loop may be initiated when a door(s) to the interior space is unlocked, upon detecting the presence of an authorized key fob or smart key inside the interior space via a proximity sensor, upon detecting (e.g., via an OMS sensor) a body pose indicating one or more keypoints representing the occupant's limb, hand, wrist, and/or palm are located within a threshold distance of the IR camera, and/or otherwise. Taking palm vein authentication as an example, the authenticating user may position their hand in front of an infrared camera (e.g., a driver monitoring system camera positioned in the steering column), the infrared camera may be used to generate an infrared image of the user's hand, hand detection and/or palm detection may be applied to the infrared image to detect a region depicting the user's hand and/or palm, and that region (or some subset thereof) may be segmented to generate a representation of an acquired vein topology.

The detected vein topology acquired from an authenticating user may be compared with one or more reference vein topologies stored in a database to determine whether the detected vein topology matches one of the reference vein topologies. For example, an acquired (e.g., binary) palm vein topology may be aligned with a reference (e.g., binary) palm vein topology, and the acquired and reference palm vein topologies may be applied to one or more machine learning models (e.g., a discriminator network) to generate a representation of whether or not corresponding regions of the acquired and reference palm vein topologies are predicted to match. A measure of the likelihood of a match and/or similarity (e.g., the number of matching regions) may be identified and compared against a designated threshold (e.g., which may depend on the resolution of the palm vein topologies and/or the regions being compared). If the measure of match likelihood and/or similar (e.g., the number of matching regions) meets or exceeds a designated threshold, the authenticating user may be authenticated. Otherwise, the acquired palm vein topology may be tested against another reference palm vein topology in the database, for example, until the user is authenticated or there are no remaining reference palm vein topologies to test.

As such, and depending on the application, one or more responsive actions may be taken in response to authenticating the user (e.g., unlock door(s); update one or more vehicle, cabin, console, and/or other setting(s) to reflect saved value(s) associated with a corresponding user profile such as seat position, mirror orientation, steering wheel position, heating and/or cooling settings, audio and/or volume presets, driving mode, console display settings, driver assistance settings, vehicle lighting, etc.; and/or other actions).

### BRIEF DESCRIPTION OF THE DRAWINGS

The present systems and methods for subcutaneous authentication are described in detail below with reference to the attached drawing figures, wherein:

FIG. 1 is a data flow diagram illustrating an example palm vein authentication pipeline, in accordance with some embodiments of the present disclosure;

FIG. 2A illustrates an example placement of a driver monitoring system camera within a steering column, and FIG. 2B is an example infrared image of an authenticating user's palm from the perspective of a driver monitoring system camera within a steering column, in accordance with some embodiments of the present disclosure;

FIG. 3 illustrates an example region of interest in the example infrared image of FIG. 2B, in accordance with some embodiments of the present disclosure;

FIG. 4 illustrates an example representation of a segmented vein topology, in accordance with some embodiments of the present disclosure;

FIGS. 5A and 5B illustrate example representations of correspondences between an acquired vein topology and a reference vein topology, in accordance with some embodiments of the present disclosure;

FIG. 6 is a flow diagram showing a method for executing one or more actions based at least on matching a representation of one or more acquired subcutaneous characteristics with a corresponding representation of one or more reference subcutaneous characteristics, in accordance with some embodiments of the present disclosure;

FIG. 7 is a flow diagram showing a method for comparing acquired and reference vein topologies, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to user authentication for vehicle access and in-cabin experience using infrared imaging. For example, systems and methods are disclosed that use infrared image data to detect one or more subcutaneous characteristics (e.g., a representation of a vein topology, such as palm vein map) of a person (e.g., a person requesting entry to a vehicle, a vehicle occupant), and to authenticate the person based on the detected subcutaneous characteristic(s). The present techniques may be utilized to authenticate a person and/or take some responsive action (e.g., unlock door(s); update one or more vehicle, cabin, console, and/or other setting(s) to reflect saved value(s) associated with or otherwise customized for a corresponding user profile such as seat position, mirror orientation, steering wheel position, heating and/or cooling settings, audio and/or volume presets, driving mode, console display settings, driver assistance settings, vehicle lighting, etc.; and/or other actions) in systems with surround view visualization, occupant monitoring (e.g., driver and/or passenger monitoring), and/or other types of systems.

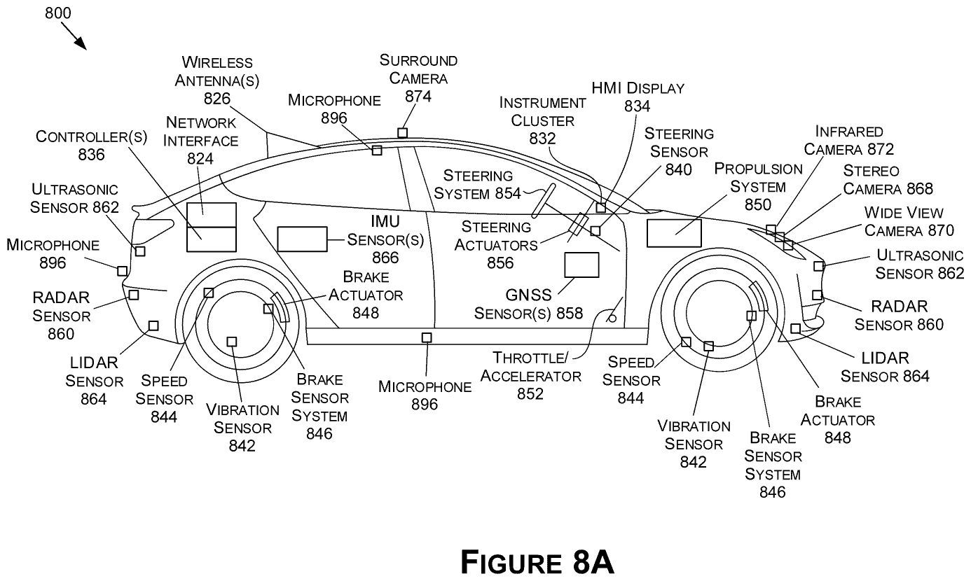

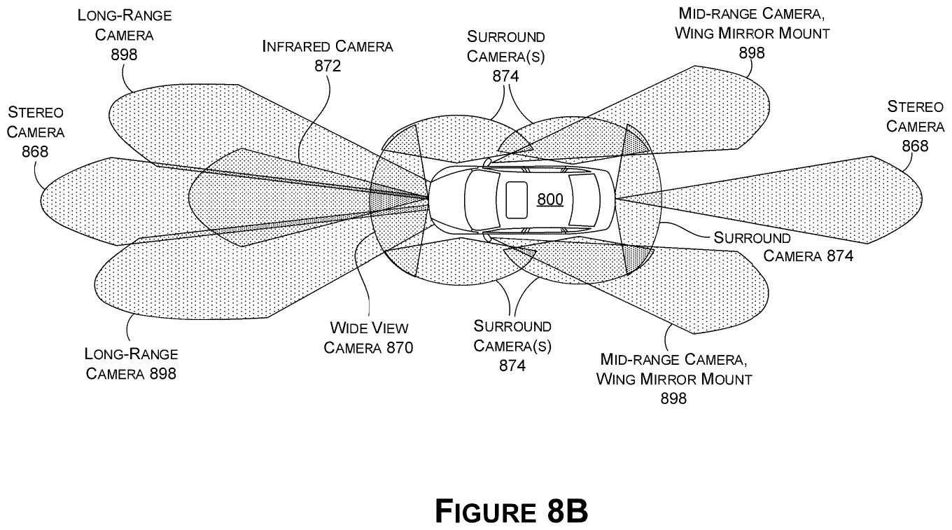

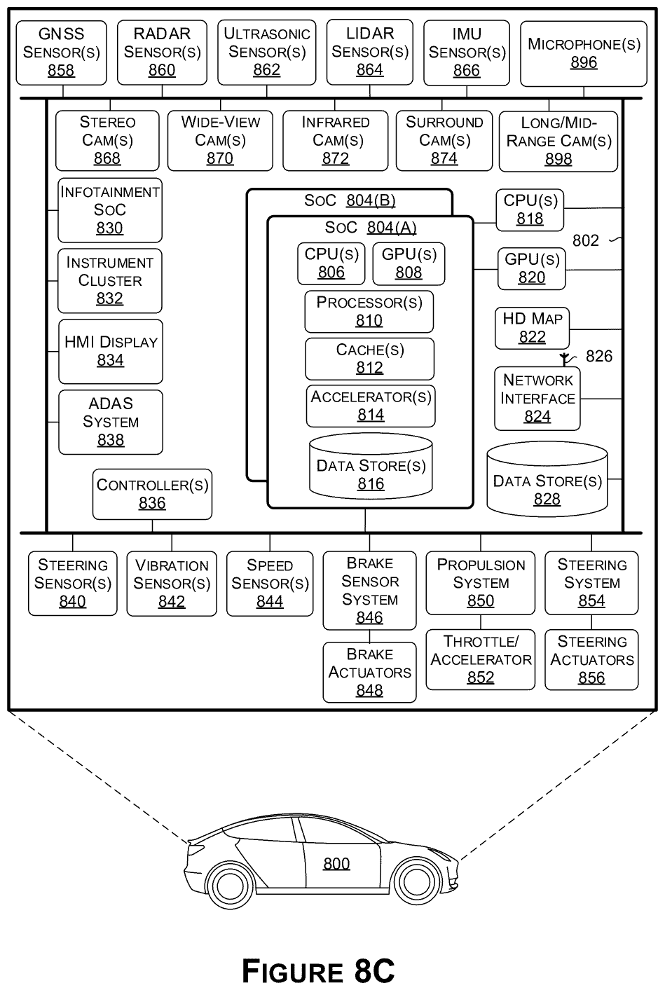

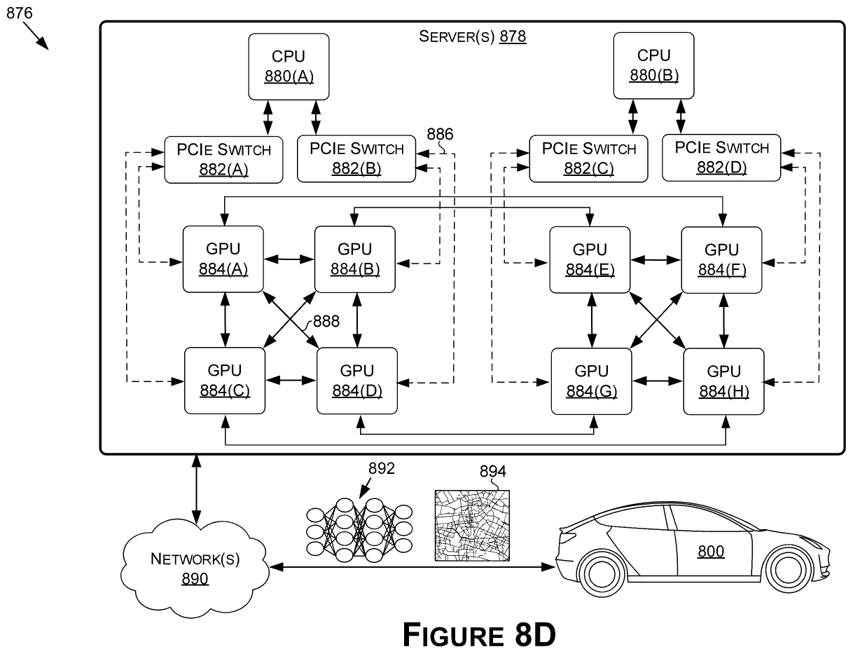

Although the present disclosure may be described with respect to an example autonomous or semi-autonomous vehicle or machine 800 (alternatively referred to herein as “vehicle 800” or “ego-machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to subcutaneous (e.g., vein topology, such as palm vein) authentication for vehicle access and in-cabin experience, this is not intended to be limiting, and the systems and methods described herein may be used in augmented reality, virtual reality, mixed reality, robotics, security and surveillance, autonomous or semi-autonomous machine applications, and/or any other technology spaces where authentication may be used.

At a high level, one or more infrared (IR) sensors (e.g., IR camera(s), combined RGB/infrared (RGB/IR) camera(s)) may be positioned to observe an authenticating user. In an example embodiment involving vehicle entry, one or more IR sensors may be positioned to observe a person requesting vehicle entry. In an example embodiment involving an occupant monitoring system (OMS), one or more IR sensors may be positioned to observe one or more occupants within a cabin, cockpit, or other interior space. For example, an OMS may comprise a driver monitoring system (DMS), a system that monitors non-driver occupants, or a system that monitors driver occupant(s) and/or non-driver occupant(s). The IR sensor(s) may use a near-infrared (NIR) light source (e.g., with a wavelength of 850 nanometers, 940 nanometers, etc.) to generate IR image data representing one or more acquired subcutaneous characteristics (e.g., a topology of veins and/or other blood vessels in a region of the authenticating user's palm, hand, neck, forearm, face, fingertip, eye, etc.). As such, the IR image data may be segmented to generate a representation of the one or more acquired subcutaneous characteristics (e.g., a binary map representing segmented veins), and the acquired subcutaneous characteristic(s) may be matched to a corresponding reference subcutaneous characteristic(s) saved in a database to authenticate the user.

Taking palm vein authentication as an example, in some embodiments, an image acquisition loop may be initiated to generate an (or multiple) IR image(s) and detect whether a suitable palm vein topology is visible in the IR image. In an example embodiment involving access to an interior space (e.g., a vehicle cabin), the image acquisition loop may be initiated upon detecting a request to unlock door(s) (e.g., via a key fob or smart key, via the push of a button such as one on a door handle), upon detecting the presence of an authorized key fob or smart key via a proximity sensor, and/or otherwise. In an example embodiment involving authentication of an occupant of an interior space, the image acquisition loop may be initiated when the door(s) to the interior space are unlocked, upon detecting the presence of an authorized key fob or smart key inside the interior space via a proximity sensor, upon detecting (e.g., via an OMS sensor) a body pose indicating one or more keypoints representing the occupant's limb, hand, wrist, and/or palm are located within a threshold distance of the IR camera, and/or otherwise. Once initiated, an image acquisition loop may (e.g., repeatedly) generate an IR image, detect the presence of a hand or palm in the IR image, normalize the pose of a detected hand or palm (e.g., by aligning a detected pose to face the IR camera and warping the IR image accordingly), and/or detect the presence of veins in one or more regions of the detected hand or palm. In some embodiments, the image acquisition loop may test the detection accuracy of the hand, palm, and/or vein detection against a corresponding confidence threshold. If a hand, palm, and/or vein topology is not detected with at least a minimum confidence, the image acquisition loop may start the loop over and acquire a new IR image. In some embodiments, the image acquisition loop may provide feedback on a display visible to the authenticating user with pose guidance instructions on how to position their hand to improve the likelihood of a positive detection (e.g., move your hand closer or farther from the camera), where the instructions may be based on the detection accuracy, the size and/or position of the region of the IR image in which a detected hand or palm was detected, a detected pose (e.g., indicating a position of the occupant's limb, hand, wrist, and/or palm relative to the IR camera), and/or other characteristics from a prior loop iteration. As such, the image acquisition loop may iterate at any designated frame rate, for example, until a vein topology is detected with at least a minimum confidence.

In some embodiments, a detected region predicted to contain a hand and/or palm (e.g., a predicted and/or normalized bounding box or other bounding shape) may be narrowed, fine-tuned, and/or otherwise processed to identify one or more regions of interest (e.g., subset region(s) of a detected region), and palm vein detection may be run on the predicted region and/or the identified region(s) of interest. For example, most palms are likely to be located in some subset of the hand (e.g., the lower 50% of the bounding box of the hand, a subset region that is sized based on the correlation between the size of the palm and the relationship between index finger and pinky, etc.), so one or more corresponding subset region(s) of a predicted bounding box or other bounding shape may be identified. In some embodiments, palm vein detection may be run separately on different regions of interest (e.g., sweeping one or more kernels across rows of a predicted bounding box to test different subset regions, making a first pass on a larger region of interest and making a second pass on smaller regions of interest such as a subset region identified by the first pass, etc.). As such, one or more subset region(s) of a predicted bounding box or other bounding shape may be identified, and palm vein detection may be run on the subset region(s).

In some embodiments, an IR image (e.g., resulting from multiplying the original IR image by a binary mask corresponding to an identified region of interest, rotated to align an identified region of interest with an input grid, such as a rectangular grid) may be segmented to extract a representation of a detected vein topology (e.g., a palm vein topology), which may include binary values representing whether each pixel is predicted to depict a detected vein. The detected vein topology acquired from an authenticating user may be compared with one or more reference vein topologies stored in a database to determine whether the detected vein topology matches one of the reference vein topologies. For example, an acquired (e.g., binary) palm vein topology may be aligned with a reference (e.g., binary) palm vein topology, and the acquired and reference palm vein topologies may be applied to one or more machine learning models (e.g., a discriminator network) to generate a representation of whether corresponding regions of the acquired and reference palm vein topology are predicted to match. A measure of the likelihood of a match and/or similarity (e.g., the number of matching regions) may be identified and compared against a designated threshold (e.g., which may depend on the resolution of the palm vein topologies and/or the regions being compared). If the measure of match likelihood and/or similar (e.g., the number of matching regions) meets or exceeds a designated threshold, the authenticating user may be authenticated. Otherwise, the acquired palm vein topology may be tested against another reference palm vein topology in the database, for example, until the user is authenticated or there are no remaining reference palm vein topologies to test.

As such, the techniques described herein may be utilized to authenticate a person and/or take some responsive action (e.g., unlock door(s); update one or more vehicle, cabin, console, and/or other setting(s) to reflect saved value(s) associated with a corresponding user profile, and/or other actions). The present techniques improve upon conventional biometric authentication techniques in terms of security and privacy. For example, subcutaneous authentication is more robust than conventional facial recognition systems since subcutaneous characteristics (e.g., an acquired palm vein topology) are only visible in infrared illumination and are therefore harder to spoof, for example, than facial recognition systems that rely on visible light. Furthermore, embodiments that authenticate based on infrared illumination of un-occluded subcutaneous characteristics (e.g., detected from the palm, hand, neck, forearm, un-occluded region of the face, fingertip, eye, etc.) obviate the failures that occur when conventional solutions attempt to authenticate based on an occluded physical attribute (e.g., when the user is wearing a mask or other facial covering). Moreover, embodiments that rely on a user positioning themselves in front of a camera to trigger an authentication request provide additional flexibility by allowing the user to choose whether or not to authenticate, as opposed to conventional facial recognition techniques in which there is no way to hide from the camera and trigger an authentication request. As such, the techniques described herein amount to improved biometric authentication techniques that can reduce the risk of unauthorized entry and/or improve convenience in accessing and operating a vehicle.

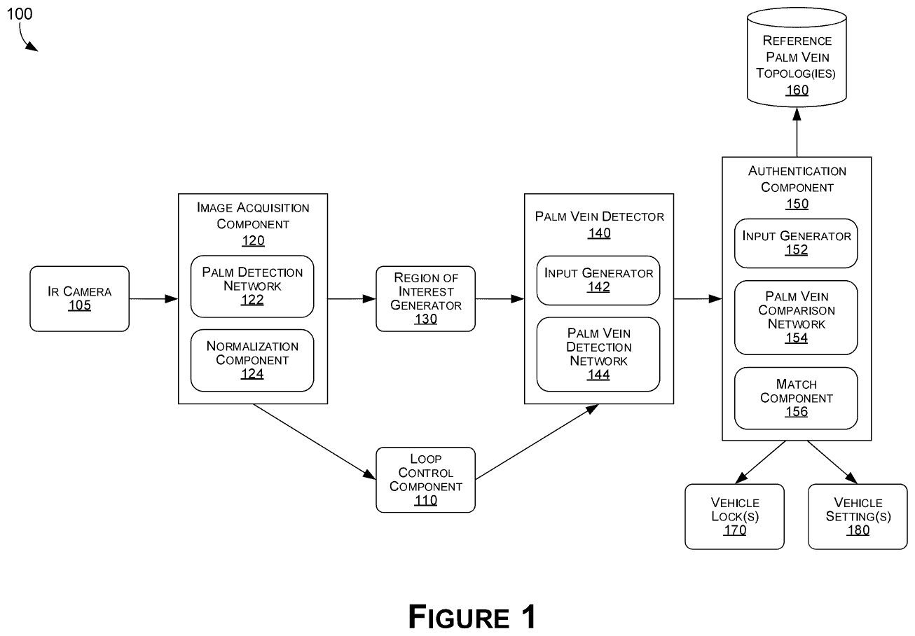

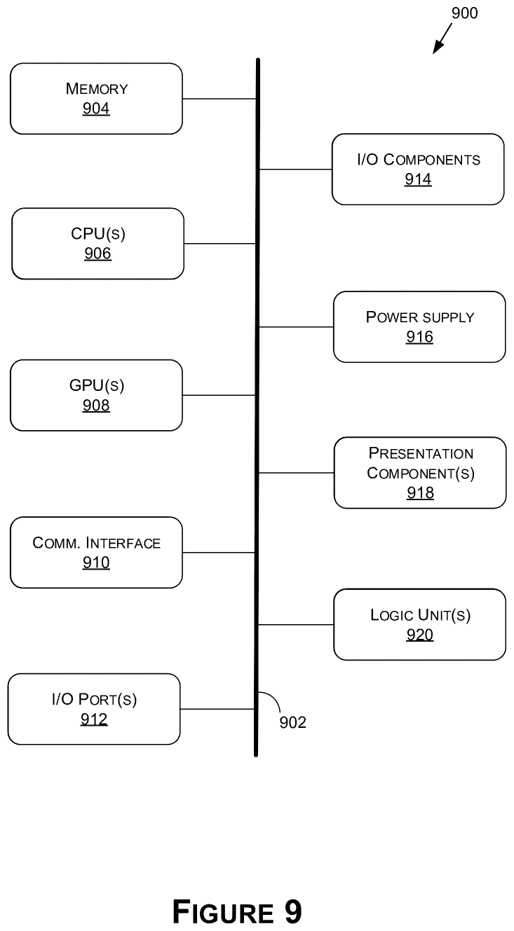

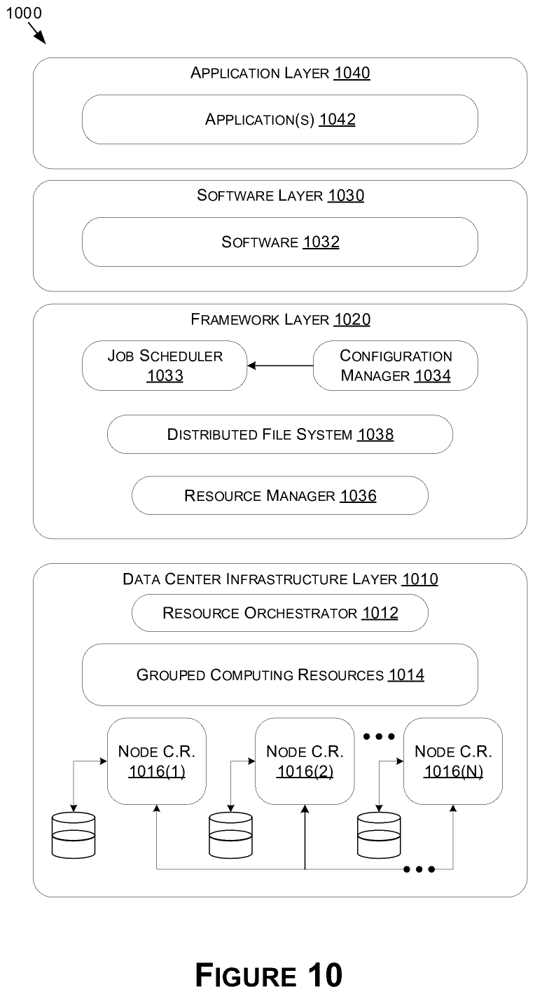

With reference to FIG. 1, FIG. 1 is an example palm vein authentication pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 800 of FIGS. 8A-8D, example computing device 900 of FIG. 9, and/or example data center 1000 of FIG. 10.

In the embodiment illustrated in FIG. 1, the palm vein authentication pipeline 100 includes an IR camera 105, a loop control component 110, an image acquisition component 120, a region of interest generator 130, a palm vein detector 140, and an authentication component 150. At a high level, the loop control component 110 may initiate and control an image acquisition loop in which the image acquisition component 120 may use the IR camera 105 to generate IR image data representing a portion of (e.g., a palm, hand, neck, forearm, face, fingertip, eye, etc. of) an authenticating user and identify and/or localize a detected hand or detected palm depicted in the IR image data, the region of interest generator 130 may identify some region of the detected hand or detected palm, and the palm vein detector 140 may segment a vein topology (or some other subcutaneous characteristic(s) that is visible in infrared illumination) from the identified region of the detected hand or detected palm. The loop control component 110 may iterate the loop at any designated rate until acquiring a detected hand or palm region and/or a segmented vein topology with a detection accuracy that meets or exceeds a threshold confidence level. As such, the authentication component 150 may compare this acquired vein topology to one or more reference vein topologies 160 representing authorized users to determine whether the authenticating user is an authorized user. If so, the authentication component 150 may determine that the authenticating user is authenticated and perform some responsive action such as granting access (e.g., unlocking one or more vehicle locks 170, applying one or more vehicle settings 180 associated with the authenticated user's profile, etc.).

The IR camera 105 (e.g., which may be a dedicated IR camera, an RGB/IR camera, and/or some other device that includes one or more IR sensor(s)) may include or otherwise coordinate with a near-infrared (NIR) light source (e.g., with a wavelength of 850 nanometers, 940 nanometers, etc.) to illuminate a target region in the field of view of the IR camera 105. As such, the IR camera 105 may include one or more IR sensors that may be used to observe IR light (e.g., radiated and/or reflected IR light) and generate IR image data representing the scene and/or object(s) in the field of view of the IR camera 105. Generally, the IR image data (e.g., an IR image) may include pixels that store values that correspond to detected temperatures, and the IR image data may take the form of a grayscale image or false-color representation in which different shades of grey or different colors are used to represent different temperatures.

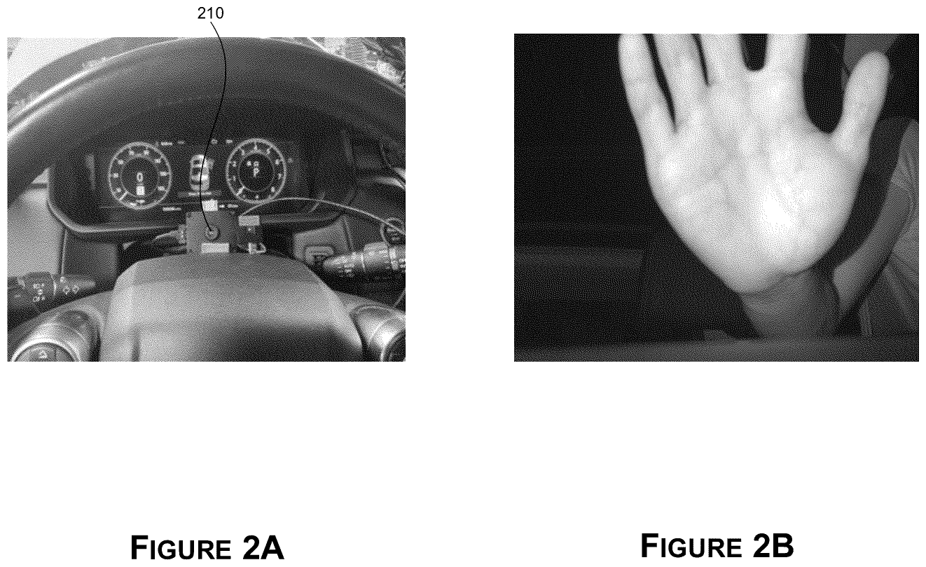

The IR camera 105 may be positioned and/or oriented to observe an authenticating user in various ways depending on the application (e.g., the security application, the area of the body being observed for one or more subcutaneous characteristics, etc.) and/or the embodiment. For example, in some embodiments that observe a topology of veins and/or other blood vessels in a particular region of the authenticating user's body, the IR camera 105 may be positioned in a manner that is accessible to the authenticating user and/or facilitates the positioning of the salient portion of an authenticating user's body in the field of view and within a suitable distance to the IR camera 105 (e.g., holding up their palm or forearm to the camera; placing their face, neck, or eye in front of the camera; etc.). Taking an example in which access (e.g., to a physical space such as a room, building, or compartment; to software or electronics such as a computing or storage device; to an (e.g., access-controlled) account; to an online service; to database or record; etc.) is secured via subcutaneous authentication, the IR camera 105 may be positioned on a wall or other component of the physical space being secured, in a computing or storage device being used to request access (e.g., an IR webcam, IR smart phone camera, etc.), and/or otherwise. In an example embodiment involving vehicle entry, the IR camera 105 may be a surround view camera (e.g., a side-view camera of the surround camera(s) 874 of the vehicle 800 of FIGS. 8A-8D equipped with infrared sensing functionality) and/or may otherwise be positioned to observe a person requesting vehicle entry. In an example embodiment involving authorization to start a vehicle's engine, or detection of a particular identity and loading one or more saved vehicle settings associated with that identity, the IR camera 105 may be part of an OMS or DMS. Vehicle manufacturers tend to vary the number of OMS cameras from model to model and depending on the trim level. Base models usually have an IR camera facing the driver (e.g., positioned within a steering column, vehicle pillar, or infotainment console). Higher trim levels may include any number of additional cameras (e.g., one in the steering column facing the driver, one in the rear review mirror facing the driver or the cabin, one in a vehicle pillar facing a particular row of seating, etc.). FIG. 2A illustrates an example implementation in which the IR camera 105 corresponds to a DMS camera 210 placed within a steering column. This is meant simply as an example, and other types of IR cameras and/or IR sensors may be positioned and/or oriented within the scope of the present disclosure.

In some embodiments, the loop control component 110 may initiate and/or control an image acquisition loop that uses the IR camera 105 to repetitively generate IR image data (e.g., an IR image) and/or otherwise accesses IR image data generated by the IR camera 105. In an example embodiment involving access to an interior space (e.g., a vehicle cabin), the loop control component 110 may initiate the image acquisition loop upon the loop control component 110 or some other component detecting a request to unlock door(s) (e.g., via a key fob or smart key, via the push of a button such as one on a door handle), upon the loop control component 110 or some other component detecting the presence of an authorized key fob or smart key via a proximity sensor, and/or otherwise. In an example embodiment involving authentication of an occupant of an interior space (e.g., in association with authorization to start a vehicle's engine, detection of a particular identity and loading one or more saved vehicle settings associated with that identity, etc.), the image acquisition loop may be initiated upon the loop control component 110 or some other component detecting the door(s) to the interior space being unlocked, upon the loop control component 110 or some other component detecting the presence of an authorized key fob or smart key inside the interior space via a proximity sensor, upon the loop control component 110 or some other component detecting (e.g., via an OMS sensor, which may be a different camera than the IR camera 105) a body pose indicating one or more keypoints representing the occupant's limb, hand, wrist, and/or palm are located within a threshold distance of the IR camera 105, and/or otherwise. In an example embodiment involving body pose detection, an OMS camera (e.g., in the rear-view mirror) may be used to detect the body pose of the vehicle operator, and the loop control component 110 may evaluate the detected body pose to determine when the detected body pose indicates the vehicle operator is positioning their hand or palm within a threshold distance of a DMS camera in the steering column.

As such, the authenticating user may position themselves and/or the salient portion of their body in the field of view of the IR camera 105. In some embodiments (e.g., upon the loop control component 110 initiating an image acquisition loop), the image acquisition component 120 may use the IR camera 105 to generate and/or otherwise access IR image data representing a portion (e.g., a palm, hand, neck, forearm, face, fingertip, eye, etc.) of the authenticating user. For example, FIG. 2B is an example infrared image of an authenticating user's palm, which may be generated in accordance with some embodiments of the present disclosure. In some embodiments, to facilitate determining whether a suitable image of the salient portion of the authenticating user's body has been generated, the image acquisition component 120 of FIG. 1 may identify and/or localize a detected hand or detected palm depicted in the IR image data, and the loop control component 110 may test a detection accuracy of the detected hand or detected palm. If the loop control component 110 determines that the detection accuracy is below a minimum confidence, the loop control component 110 may acquire a new IR image (e.g., at a designated frame rate).

In the embodiment illustrated in FIG. 1, the subcutaneous characteristic(s) being used to authenticate may include a palm vein topology, so the image acquisition component 120 may include a palm detection network 122 and a normalization component 124. At a high level, the palm detection network 122 (or a hand detection network) may include one or more machine learning models (e.g., one or more deep neural networks or “DNNs”) that detect and/or localize (e.g., a bounding box or other bounding shape and/or one or more keypoints representing a pose of) a hand or palm in the IR image data, and the normalization component 124 may normalize the pose of the detected hand or palm (e.g., by aligning a detected pose to face the IR camera 105 and warping the IR image accordingly).

In some embodiments, the palm detection network 122 (and/or any of the other machine learning models and/or detection networks described herein, such as the palm vein detection network 144 and/or the palm vein comparison network 154) may be implemented using a DNN, such as a convolutional neural network (CNN). Although certain embodiments are described with the palm detection network 122, the palm vein detection network 144, and/or the palm vein comparison network 154 being implemented using neural network(s), this is not intended to be limiting. For example, and without limitation, the palm detection network 122, the palm vein detection network 144, and/or the palm vein comparison network 154 may include any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), Hopfield, Boltzmann, deep belief, de-convolutional, generative adversarial, liquid state machine, etc.), and/or other types of machine learning models.

In some embodiments, the palm detection network 122 (and/or any of the other machine learning models and/or detection networks described herein, such as the palm vein detection network 144 and/or the palm vein comparison network 154) may include a common trunk (or stream of layers) with several input and/or output heads (or at least partially discrete streams of layers) for accepting different inputs and/or predicting different outputs. For example, the palm detection network 122, may include, without limitation, a feature extractor (e.g., a DNN, an encoder/decoder, etc.) including convolutional layers, pooling layers, and/or other layer types, where the output of the feature extractor may be provided as input to a plurality of output heads (e.g., classification and/or regression heads) for detecting and/or classifying pixels that are likely to depict a detected hand or palm (or one or more keypoints or other portions thereof), detecting and/or regressing coordinates of a bounding shape (or one or more keypoints or other portions) of a detected hand and/or palm, and/or the like. As such, any known post-processing technique may be applied to decode the predicted classification data and/or regression data to generate a bounding box, closed polyline(s), and/or other bounding shape identifying the location, size, and/or orientation of a detected hand or palm, and/or of one or more keypoints representing a detected pose of the hand or palm. These and the other architectures described herein are meant simply as examples, and other architectures may be implemented within the scope of the present disclosure. Although some embodiments are described with respect to hand or palm detection, some embodiments may additionally or alternatively detect and/or localize other parts of the body, for example, based on the location of the subcutaneous characteristic(s) being authenticated (e.g., the neck, forearm, face, fingertip, eye, a salient portion thereof, etc.).

In some embodiments, the loop control component 110 may test a detection accuracy of the detected hand or detected palm. For example, the palm detection network 122 may predict classification data (e.g. a binary classification for the entire IR image, per-pixel classification data) representing a likelihood that the IR image and/or each individual pixel depicts a hand and/or palm. As such, the loop control component 110 may identify a prediction confidence (e.g., for the binary classification of the entire IR image predicted by the palm detection network 122, an aggregated and/or statistical value representing the prediction confidence of a plurality of per-pixel classifications such as an average prediction confidence for pixels located within a predicted bounding box, etc.), and the loop control component 110 may use the identified prediction confidence as a detection accuracy and test the prediction confidence against a designated confidence threshold. If the loop control component 110 determines that the detection accuracy is below a minimum confidence level, the loop control component 110 may acquire a new IR image (e.g., at a designated frame rate). If the loop control component 110 determines that the detection accuracy meets or exceeds the minimum confidence level, the loop control component 110 may advance to the next step in the process (e.g., in the palm vein authentication pipeline 100). Although application of this threshold is described as occurring at a particular step in the process, this need not be the case, and application of this and/or other thresholds described herein may occur at any step in the process.

In some embodiments, the image acquisition component 120 includes a normalization component 124. For example, some embodiments may seek to detect one or more subcutaneous characteristics in a particular part of the body like the hand or palm, and certain poses may facilitate a positive detection. For example, positive detections may be facilitated by positioning an open palm facing the IR camera 105. As such, in some embodiments, the normalization component 124 may align a detected pose (e.g., represented as 2D and/or 3D coordinates of a plurality of keypoints detected by the palm detection network 122) with a designated pose (e.g., facing the IR camera 105), for example, by fitting the detected keypoints to a 3D model of a hand, and rotating the 3D model to have the designated pose. As such, the normalization component 124 may warp the IR image data (and/or corresponding predicted classification data, regression data, bounding shape, etc.) to the rotated keypoints to generate normalized IR image data that represents the designated pose.

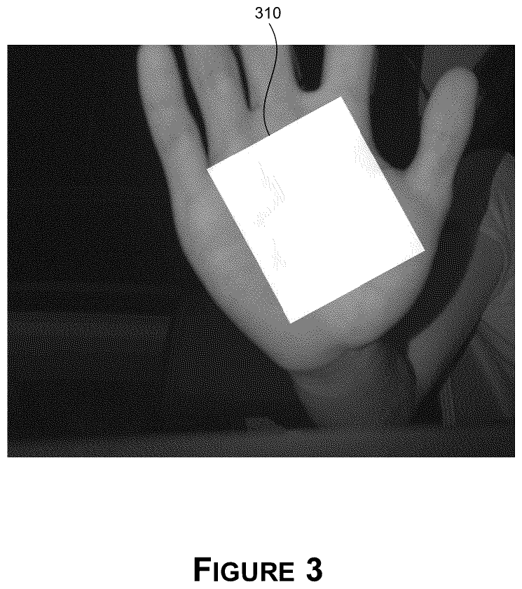

In some embodiments, the image acquisition component 120 includes a region of interest generator 130. The region of interest generator 130 may generate a representation of one or more narrowed, fine-tuned, and/or otherwise identified regions of interest (e.g., subset region(s)) of the detected hand or palm (or other region of the authenticating user's body) represented in the (e.g., normalized) IR image data. Taking a detected hand as an example, most palms are likely to be located in some subset of the hand (e.g., the lower 50% of the bounding box of the hand, a subset region sized based on the correlation between the size of the palm and the relationship between index finger and pinky, etc.), so the region of interest generator 130 may identify one or more corresponding subset region(s) of a (e.g., normalized) bounding box or other bounding shape predicted to contain a detected hand (e.g., by scaling a predicted bounding box in one or more dimensions by a designated percentage or calculated ratio). FIG. 3 illustrates an example region of interest 310 (e.g., representing the palm of an authenticating user) that is a subset of the example infrared image of FIG. 2B, in accordance with some embodiments of the present disclosure.

As such, the region of interest generator 130 may provide a representation of one or more regions of interest of the detected hand or palm, and the palm vein detector 140 may detect the presence of and/or otherwise generate a representation of detected veins within (e.g., a predicted bounding box or other bounding shape representing) a detected hand or palm and/or one or more regions of interest therein. In some embodiments, the palm vein detector 140 may execute separately on different regions of interest (e.g., sweeping one or more kernels across rows of a predicted bounding box to test different subset regions, making a first pass on a larger region of interest and making a second pass on smaller regions of interest such as a subset region identified by the first pass, etc.). As such, the region of interest generator 130 may identify and provide the palm vein detector 140 with a representation of one or more subset region(s) of (e.g., a predicted bounding box or other bounding shape representing) a detected hand or palm, and the palm vein detector 140 may process the detected hand or palm and/or the one or more subset region(s) to detect (e.g., segment) veins represented in the detected hand or palm and/or the one or more subset region(s).

In the example illustrated in FIG. 1, the palm vein detector 140 includes an input generator 142 and a palm vein detection network 144. Given a representation of (e.g., a binary mask representing) a bounding box or other bounding shape representing a detected hand and/or palm and/or a subset region thereof, the input generator 142 may generate and/or otherwise prepare IR image data representing the detected hand, palm, and/or subset region in a format that the palm vein detection network 144 accepts. For example, the input generator 142 may multiply the IR image data (e.g., the IR image generated using the IR camera 105, normalized IR image data generated by the normalization component 124) by a binary mask representing the region to be tested (e.g., the region of interest 310 of FIG. 3), rotate the (e.g., resulting) IR image data to align the region being tested with a rectangular grid, and/or apply the (e.g., resulting) IR image data to the palm vein detection network 144.

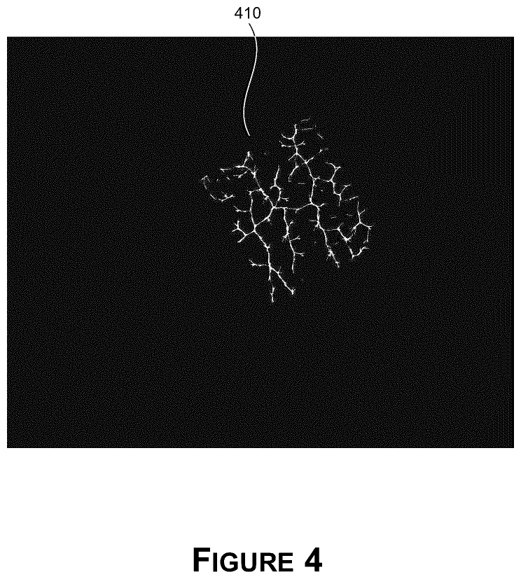

As such, the palm vein detection network 144 may segment the (e.g., resulting) input IR image data to generate a representation of one or more detected veins depicted in the input IR image data. For example, the palm vein detection network 144 may include, without limitation, a feature extractor (e.g., a DNN, an encoder/decoder, etc.) including convolutional layers, pooling layers, and/or other layer types, where the output of the feature extractor may be provided to a classification head for detecting and/or classifying pixels that are likely to depict a vein (or some other blood vessel or other subcutaneous characteristic(s) that is visible in IR illumination). In some embodiments, the palm vein detection network 144 may apply class segmentation (e.g., by applying a threshold per-pixel prediction confidence) to identify pixels that are likely to depict a vein. As such, the palm vein detection network 144 may predict, segment, and/or otherwise generate a (e.g., binary) representation of an acquired (e.g., palm) vein topology for an authenticating user. FIG. 4 illustrates an example representation of a segmented palm vein topology 410, in accordance with some embodiments of the present disclosure.

In some embodiments, the loop control component 110 may test a detection accuracy of the detected veins. For example, the palm vein detection network 144 may predict classification data (e.g. a binary classification for the entire input IR image, per-pixel classification data) representing a likelihood that the input IR image and/or each individual pixel depicts a detected vein. As such, the loop control component 110 may identify a prediction confidence (e.g., for the binary classification of the entire input IR image predicted by the vein detection network 144, an aggregated and/or statistical value representing the prediction confidence of a plurality of per-pixel classifications such as an average prediction confidence for the pixels within the region being tested, etc.), and the loop control component 110 may use the identified prediction confidence as a detection accuracy and test the prediction confidence against a designated confidence threshold. If the loop control component 110 determines that the detection accuracy is below a minimum confidence level, the loop control component 110 may acquire a new IR image. If the loop control component 110 determines that the detection accuracy meets or exceeds the minimum confidence level, the loop control component 110 may advance to the next step in the process (e.g., in the palm vein authentication pipeline 100).

In some embodiments, when the loop control component 110 triggers or otherwise in association with triggering the image acquisition component 120 to acquire another frame of IR image data, the loop control component 110 may trigger presentation of feedback on a display that is visible to the authenticating user with pose guidance instructions on how to position their hand (or other portion of their body) to improve the likelihood of a positive detection (e.g., move your hand closer or farther from the camera, move your hand to the left or to the right, move your hand up or down, rotate your hand to face the camera, etc.). The loop control component 110 may determine which instructions to provide based on the detection accuracy (e.g., of the palm detection network 122, the palm vein detection network 144), the size and/or position of the region of the IR image in which a detected hand or palm was detected (e.g., by the palm detection network 122), a detected pose (e.g., indicating a position of the occupant's limb, hand, wrist, and/or palm relative to the IR camera), and/or other characteristics from a prior loop iteration. In an example embodiment involving body pose detection, an OMS camera (e.g., in the rear-view mirror) may be used to detect the body pose of the vehicle operator, and the loop control component 110 may evaluate the detected body pose to detect the distance and/or positioning of the vehicle operator's hand relative to a DMS camera in the steering column. As such, the loop control component 110 may determine which direction the vehicle operator should move their hand and/or any recommended changes in orientation of their hand pose, and the loop control component 110 may trigger the display to present corresponding instructions. As such, the loop control component 110 may trigger any number of iterations of an image acquisition loop operating at any designated frame rate (e.g., 5 frames per second (fps), 10 fps, 20, 30, etc.), for example, until a vein topology (or other subcutaneous characteristic(s)) is detected with at least a minimum confidence.

In some embodiments, the authentication component 150 may compare the acquired palm vein topology for the authenticating user to one or more reference palm vein topolog(ies) 160 representing authorized users to determine whether the authenticating user is an authorized user. Reference vein palm vein topolog(ies) 160 may be registered using any suitable technique. For example, a vehicle owner and/or an authorized user may create or update a user profile (e.g., via interactions with a display such as an infotainment console). As part of the process, the vehicle owner and/or authorized user may be prompted to register their palm vein topology (or other subcutaneous characteristic(s)), in which case, a representation of their palm vein topology may be acquired using the techniques described herein (e.g., using the loop control component 110, the image acquisition component 120, the region of interest generator 130, and/or the palm vein detector 140). In some embodiments, one or more cabin, console, and/or other setting(s) may be saved and/or otherwise associated with their user profile, such as seat position, mirror orientation, steering wheel position, heating and/or cooling settings, audio and/or volume presets, driving mode, console display settings, driver assistance settings, vehicle lighting, and/or others.

As such, the authentication component 150 may access one of the reference palm vein topolog(ies) 160 registered in a database (e.g., residing in the vehicle, at some remote location accessible via a wireless communication network), and compare the acquired vein topology to the palm reference vein topology 160. In the example illustrated in FIG. 1, the authentication component 150 includes an input generator 152, a palm vein comparison network 154, and a match component 156.

In some embodiments, the input generator 152 may align (e.g., binary) representations of an acquired palm vein topology with a reference palm vein topology (e.g., rotate one or both to align with an input (e.g., rectangular) grid, rotate one or both to have a comparable pose, center or otherwise position one or both in a particular region of a frame such as a central region, etc.). As such, the input generator 152 may apply the acquired and reference palm vein topologies to the palm vein comparison network 154 to generate a representation of whether corresponding regions of the acquired and reference palm vein topology are predicted to match, and the match component 156 may decode the output of the palm vein comparison network 154 to determine whether the acquired and reference palm vein topology are predicted to match.

For example, the palm vein comparison network 154 may comprise one or more machine learning models (e.g., a discriminator network) that compare corresponding regions of (e.g., binary masks representing) the acquired and reference palm vein topologies and generate a representation of whether the corresponding regions match. For example, the palm vein comparison network 154 may include, without limitation, one or more feature extractors (e.g., a DNN, an encoder/decoder, etc.) including convolutional layers, pooling layers, and/or other layer types to extract and/or compare features of the acquired and reference palm vein topologies. The palm vein comparison network 154 may predict a correspondence map that quantifies the similarity and/or likelihood that corresponding regions of the acquired and reference palm vein topologies match. For example, each element in the correspondence map may quantify similarity and/or likelihood of a match between a portion of (e.g., a binary mask representing) one topology and a corresponding portion of (e.g., a binary mask representing) the other topology within a receptive field with a designated size (e.g., 5×5 pixels). By way of non-limiting example, a representation of a palm vein topology may have a pixel resolution of 630×430, and the palm vein comparison network 154 may predict a correspondence map with a resolution of 126×86 based on a receptive field that compares corresponding 5×5 pixel regions of the acquired and reference palm vein topologies. As such, each element in the predicted output (e.g., a predicted correspondence map) may quantify a likelihood that corresponding regions of the acquired and reference palm vein topologies match.

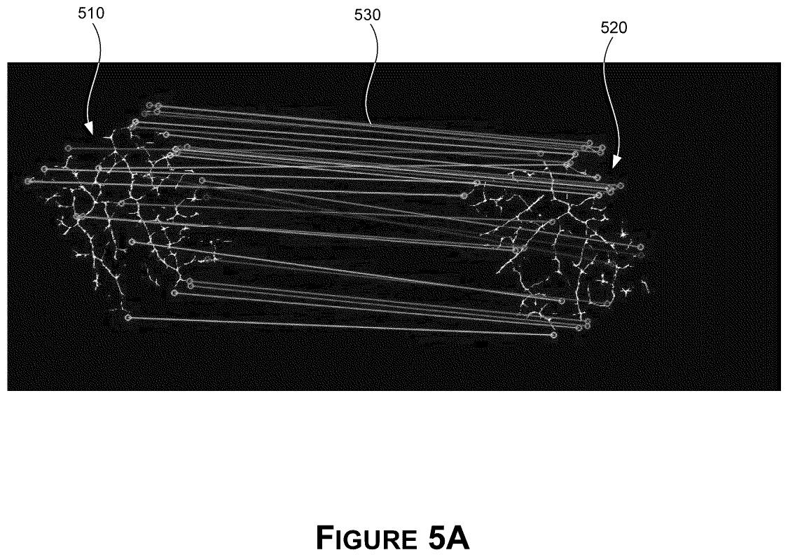

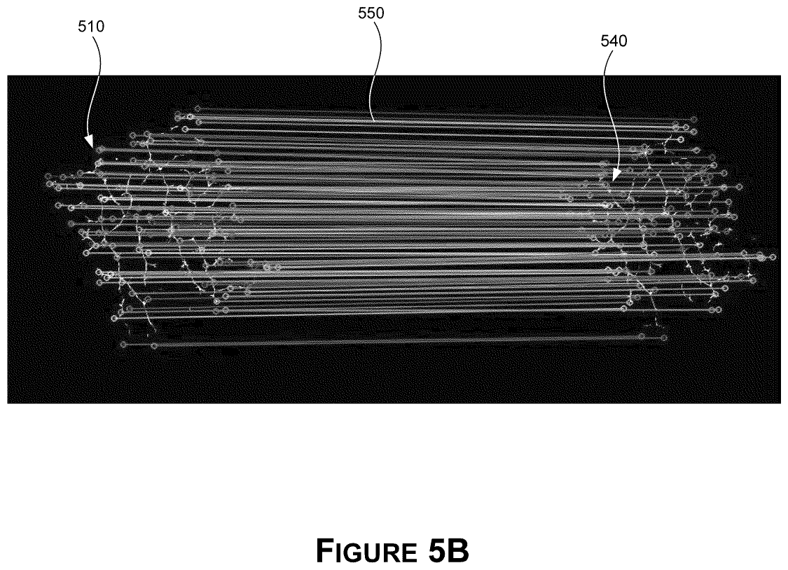

Accordingly, the match component 156 may quantify the number of matching regions, for example, by applying a threshold confidence (e.g., 85%) to each element of the predicted output (e.g., a predicted correspondence map). As such, the match component 156 may identify the number of matching regions between the acquired and reference palm vein topologies, and the match component 156 may compare that number against a designated threshold, which may depend on the resolution of the palm vein topologies, the size of the receptive field, the region of the body being compared, and/or other factors. Continuing with the example above using a palm vein topology with a pixel resolution of 630×430 and a correspondence map with a resolution of 126×86, a comparison between acquired and reference vein topologies that do not match may result in approximately 20 matching regions, whereas a comparison between acquired and reference vein topologies that do match may result in approximately 100 matches, so a threshold such as 70 may be applied. FIG. 5A is a visualization of example correspondences 530 between an acquired vein topology 510 and a reference vein topology 520 that do not match, and FIG. 5B is a visualization of example correspondences 550 between an acquired vein topology 510 and a reference vein topology 540 that do match.

As such, if the match component 156 may determine whether the number of matching regions meets or exceeds a designated threshold, and if so, the match component 156 may determine that the authenticating user is an authorized user and is therefore authenticated. Otherwise, the authentication component 150 may test the acquired palm vein topology against another reference vein topology 160 in the database, for example, until the user is authenticated or there are no remaining reference palm vein topologies to test. If the authentication component 150 (e.g., the match component 156) determines that the user is authenticated, the authentication component 150 may perform some responsive action such as granting access (e.g., triggering one or more actuators to unlock one or more corresponding vehicle locks 170, applying one or more saved settings (e.g., vehicle setting(s) 180) associated with the authenticated user's profile, etc.).

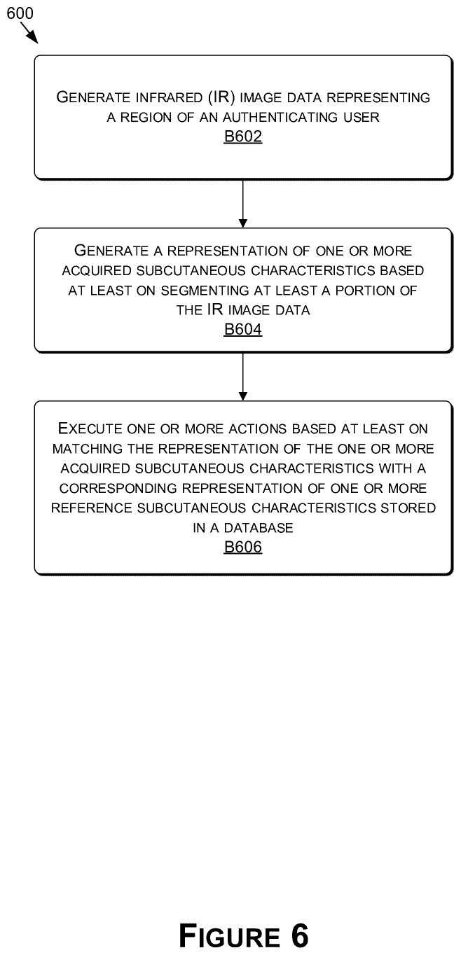

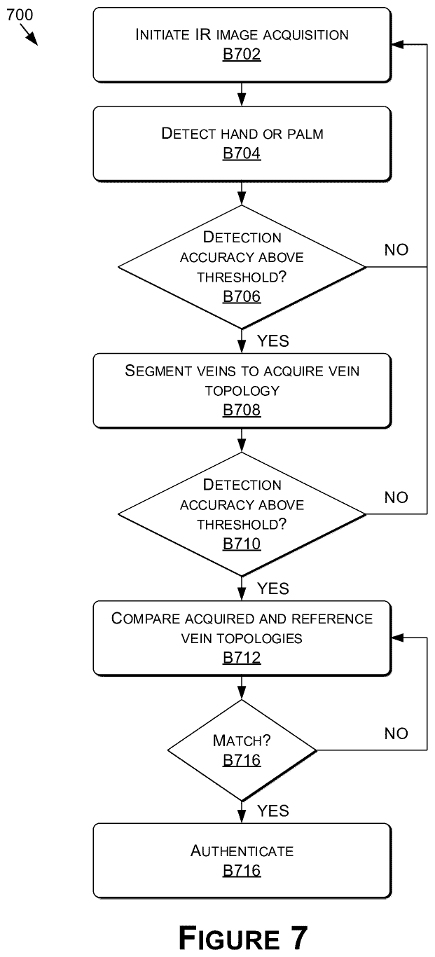

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 600 and 700 are described, by way of example, with respect to the palm vein authentication pipeline 100 of FIG. 1. However, these methods may additionally or alternatively be executed by any one system, or any combination of systems, including, but not limited to, those described herein.

FIG. 6 is a flow diagram showing a method 600 for executing one or more actions based at least on matching a representation of one or more acquired subcutaneous characteristics with a corresponding representation of one or more reference subcutaneous characteristics, in accordance with some embodiments of the present disclosure. The method 600, at block B602, includes generating IR image data representing a region of an authenticating user. For example, with respect to FIG. 1, the image acquisition component 120 may use the IR camera 105 to generate IR image data representing a portion of (e.g., a palm, hand, neck, forearm, face, fingertip, eye, etc. of) an authenticating user.

The method 600, at block B604, includes generating a representation of one or more acquired subcutaneous characteristics based at least on segmenting at least a portion of the IR image data. For example, with respect to FIG. 1, the image acquisition component 120 (e.g., the palm detection network 122) may identify and/or localize a detected hand or detected palm depicted in the IR image data, and/or the palm vein detector 140 may segment a vein topology (or some other subcutaneous characteristic(s) that is visible in infrared illumination) from the IR image data and/or a portion thereof. In some embodiments, the region of interest generator 130 may identify and provide the palm vein detector 140 with a representation of one or more subset region(s) of (e.g., a predicted bounding box or other bounding shape representing) a detected hand or palm, and the palm vein detector 140 may process the detected hand or palm and/or the one or more subset region(s) to detect (e.g., segment) veins represented in the detected hand or palm and/or the one or more subset region(s).

The method 600, at block B606, includes executing one or more actions based at least on matching the representation of the one or more acquired subcutaneous characteristics with a corresponding representation of one or more reference subcutaneous characteristics stored in a database. For example, with respect to FIG. 1, the authentication component 150 may compare an acquired palm vein topology for an authenticating user to one or more reference palm vein topologies 160 representing authorized users to determine whether the authenticating user is an authorized user. If the authentication component 150 (e.g., the match component 156) determines that the user is authenticated, the authentication component 150 may perform some responsive action such as granting access (e.g., triggering one or more actuators to unlock one or more corresponding vehicle locks 170, applying one or more saved settings (e.g., vehicle setting(s) 180) associated with the authenticated user's profile, etc.).

FIG. 7 is a flow diagram showing a method 700 for comparing acquired and reference vein topologies, in accordance with some embodiments of the present disclosure. The method 700, at block B702, includes initiating IR image acquisition. For example, with respect to FIG. 1, the loop control component 110 may initiate and/or control an image acquisition loop in which the image acquisition component 120 uses the IR camera 105 to generate and/or otherwise access IR image data representing a portion of (e.g., a palm, hand, neck, forearm, face, fingertip, eye, etc. of) an authenticating user.

The method 700, at block B704, includes detecting a hand or palm represented in an acquired IR image. For example, with respect to FIG. 1, the image acquisition component 120 (e.g., the palm detection network 122) may identify and/or localize a detected hand or detected palm depicted in the acquired IR image.

The method 700, at block B706, tests whether the detection accuracy is above a designated threshold. For example, with respect to FIG. 1, the loop control component 110 may test a detection accuracy of the detected hand or detected palm detected at block B704. For example, the loop control component 110 may identify a prediction confidence (e.g., for the binary classification of the entire IR image predicted by the palm detection network 122, an aggregated and/or statistical value representing the prediction confidence of a plurality of per-pixel classifications such as an average prediction confidence for pixels located within a predicted bounding box, etc.), and the loop control component 110 may use the identified prediction confidence as a detection accuracy and test the prediction confidence against a designated confidence threshold. If the detection accuracy does not meet the designated threshold, the method 700 returns to block B702 to acquire a new IR image. Otherwise, the method 700 advances to block B708.

The method 700, at block B708, includes segmenting veins to acquire a vein topology for the authenticating user. For example, with respect to FIG. 1, the palm vein detector 140 may segment a vein topology from the acquired IR image data and/or a portion thereof. In some embodiments, the region of interest generator 130 may identify and provide the palm vein detector 140 with a representation of one or more subset region(s) of (e.g., a predicted bounding box or other bounding shape representing) a detected hand or palm, and the palm vein detector 140 may process the detected hand or palm and/or the one or more subset region(s) to detect (e.g., segment) veins represented in the detected hand or palm and/or the one or more subset region(s).

The method 700, at block B710, tests whether the detection accuracy is above a designated threshold. For example, with respect to FIG. 1, the loop control component 110 may test a detection accuracy of the detected veins segmented at block B708. For example, the loop control component 110 may identify a prediction confidence (e.g., for the binary classification of the entire input IR image predicted by the vein detection network 144, an aggregated and/or statistical value representing the prediction confidence of a plurality of per-pixel classifications such as an average prediction confidence for the pixels within the region being tested, etc.), and the loop control component 110 may use the identified prediction confidence as a detection accuracy and test the prediction confidence against a designated confidence threshold. If the detection accuracy does not meet the designated threshold, the method 700 returns to block B702 to acquire a new IR image. Otherwise, the method 700 advances to block B712.

The method 700, at block B712, includes comparing the acquired and reference vein topologies. For example, with respect to FIG. 1, the input generator 152 may apply a representation of the acquired and reference palm vein topologies to the palm vein comparison network 154 to generate a representation of whether corresponding regions of the acquired and reference palm vein topology are predicted to match, such as a correspondence map that quantifies likelihoods that corresponding regions of the acquired and reference palm vein topologies match.

The method 700, at block B714, includes determining whether the acquired and reference vein topologies are match. For example, with respect to FIG. 1, the match component 156 may quantify the number of matching regions, for example, by applying a threshold confidence (e.g., 85%) to each element of the predicted output (e.g., a predicted correspondence map). As such, the match component 156 may identify the number of matching regions between the acquired and reference palm vein topologies, and the match component 156 may compare that number against a designated threshold. If the number of matching regions does not meet the designated threshold, the method 700 may return to block B712 to test the acquired palm vein topology against another reference vein topology (if there are any left to test). If the number of matching regions does meet the designated threshold, the method 700, at block B716, includes determining that the user is authenticated.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), one or more occupant monitoring system (OMS) sensor(s) 801 (e.g., one or more interior cameras), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

Cameras with a field of view that include portions of the interior environment within the cabin of the vehicle 800 (e.g., one or more OMS sensor(s) 801) may be used as part of an occupant monitoring system (OMS) such as, but not limited to, a driver monitoring system (DMS). For example, OMS sensors (e.g., the OMS sensor(s) 801) may be used (e.g., by the controller(s) 836) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 804 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 816 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884 (A)-884 (H) (collectively referred to herein as GPUs 884), PCIe switches 882 (A)-882 (H) (collectively referred to herein as PCIe switches 882), and/or CPUs 880 (A)-880 (B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to:
generate infrared (IR) image data representing a region of an authenticating user;
generate a representation of one or more acquired subcutaneous characteristics based at least on segmenting at least a portion of the IR image data; and
execute one or more actions based at least on matching the representation of the one or more acquired subcutaneous characteristics with a corresponding representation of one or more reference subcutaneous characteristics stored in a database.

2. The processor of claim 1, the one or more processing units further to initiate an IR image acquisition loop, using an IR camera observing an interior space, based on at least one of: detecting one or more doors to the interior space being unlocked, detecting an authorized key via a proximity sensor, or detecting a body pose indicating one or more of a limb, hand, wrist, or palm of the authenticating user within a threshold distance of the IR camera.

3. The processor of claim 1, the one or more processing units further to initiate an IR image acquisition loop, using an IR camera observing an exterior space, based on at least one of detecting a request to unlock one or more doors or detecting an authorized key via a proximity sensor.

4. The processor of claim 1, the one or more processing units further to execute an IR image acquisition loop configured to generate frames of the IR image data and test a detection accuracy of corresponding instances of the one or more acquired subcutaneous characteristics represented in the frames of the IR image data against a threshold confidence.

5. The processor of claim 1, the one or more processing units further to execute an IR image acquisition loop configured to repetitively generate instances of the IR image data, apply at least one of hand detection or palm detection to detect a hand region or palm region represented in the IR image data, apply vein detection to the hand region or the palm region, and test a detection accuracy of at least one of the hand detection, the palm detection, or the vein detection.

6. The processor of claim 1, the one or more processing units further to generate a representation of a detected hand or a detected palm represented by the IR image data, normalize a pose of the detected hand or the detected palm based at least on warping the IR image data, and detect veins in one or more regions of the detected hand or the detected palm.

7. The processor of claim 1, the one or more processing units further to detect a hand region of the IR image data predicted to depict a hand, identify a palm region that is a subset of the hand region, and apply vein detection on the palm region.

8. The processor of claim 1, wherein the representation of the one or more acquired subcutaneous characteristics comprises a binary representation of an acquired vein topology of the authenticating user.

9. The processor of claim 1, wherein the one or more acquired subcutaneous characteristics of the authenticating user comprise a vein topology of a palm, neck, forearm, finger, or eye of the authenticating user.

10. The processor of claim 1, wherein the representation of the one or more acquired subcutaneous characteristics comprises an acquired palm vein topology of the authenticating user, the corresponding representation of one or more reference subcutaneous characteristics comprises a reference palm vein topology of an authorized user, and the matching comprises applying representations of the acquired palm vein topology and the reference palm vein topology to a discriminator network.

11. The processor of claim 1, wherein the one or more actions comprise updating one or more of a seat position, a mirror orientation, a steering wheel position, a heating or cooling setting, an audio or volume preset, a driving mode, a console display setting, a driver assistance setting, or vehicle lighting to reflect one or more corresponding saved values associated with a user profile of the authenticating user.

12. The processor of claim 1, wherein the one or more actions comprise unlocking one or more doors.

13. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

14. A system comprising one or more processing units to execute one or more actions based at least on matching a representation of an acquired vein topology with a corresponding representation of a reference vein topology stored in a database.

15. The system of claim 14, the one or more processing units further to execute an IR image acquisition loop configured to repetitively generate instances of IR image data, apply hand detection or palm detection to detect a hand region or palm region represented in the IR image data, apply vein detection to the hand region or the palm region to segment the acquired vein topology, and test a detection accuracy of at least one of the hand detection, the palm detection, or the vein detection.

16. The system of claim 14, the one or more processing units further to generate a representation of a detected hand or a detected palm represented by IR image data, normalize a pose of the detected hand or the detected palm based at least on warping the IR image data, and detect the acquired vein topology in one or more regions of the detected hand or the detected palm.

17. The system of claim 14, the one or more processing units further to detect a hand region represented in IR image data and predicted to depict a hand, identify a palm region that is a subset of the hand region, and apply vein detection on the palm region to segment the acquired vein topology.

18. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
generating a representation of an acquired vein topology of an authenticating user based at least on segmenting at least a portion of IR image data representing a region of the authenticating user;
authenticating the authenticating user based at least on matching the representation of the acquired vein topology with a corresponding representation of a reference vein topology stored in a database; and
executing one or more actions based on the authenticating of the authenticating user.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center, or
a system implemented at least partially using cloud computing resources.
